(19) United States
(12) Patent Application Publication
(10) Pub. No.: US 2010/0140426 A1
(43) Pub. Date: Jun. 10, 2010

(54) Vehicle Headrest Accessory Mount

(75) Inventor: Corey Aaron Bennett, Merrill, WI (US)

Correspondence Address: Corey A. Bennett, 203 N Court St., Merrill, WI, 54452, US

(73) Assignee: Corey Aaron Bennett, Merrill, WI (US)

(21) Appl. No.: 12/328,005

(22) Filed: Dec. 4, 2008

(51) Int. Cl. B60N 2/44

(52) U.S. Cl. 248/205.1

(57) ABSTRACT

The Vehicle Headrest Accessory (VHR) mount is a direct substitution part for the OEM installed headrest in commercially manufactured vehicles. The VHR mount is only an accessory mounting structure or framework which utilizes the existing support structure or framework of a vehicle seat equipped with an adjustable headrest. The VHR mount is an improvement of a vehicle seat manufactured or adapted to receive an adjustable headrest and it is a unique item of manufacture in its spirit, purpose, and scope by providing surface area to attach unspecified accessories in an otherwise occupied space.

### BACKGROUND

The present invention relates generally to an accessory mounting structure, and more particularly, to a headrest substitution accessory mounting structure, which can be installed in place of the OEM vehicle headrest.

The present invention was born due to space limitations in police vehicles. Police vehicles require a large amount of additional accessory installations, historically placed in the center console area of the vehicle or mounted to the protective partition. The emergence of mobile office products have further complicated this installation process while still trying to provide operator and passenger space. An additional complication is maintaining sufficient access to each individual accessory. An example is a police vehicle with a partition mounted weapon system such a police rifle. An armrest which contains a mobile printer would traditionally be placed near the driver seat and possibly attached the to center console directly in front of the rifle. Although the armrest and printer serve their purpose, access to the rifle is now limited or at least made more difficult from the armrest obstruction. The vehicle headrest accessory mount addresses this problem by allowing the armrest printer station to be attached to the vehicle headrest accessory mount and installed in place of the passenger side headrest within easy and unobstructed reach of the operator.

### SUMMARY OF THE INVENTION

The Vehicle Headrest Accessory (VHR) mount is a direct substitution part for the factory installed headrest in commercially manufactured vehicles. The VHR mount is composed of rigid material, preferably metallic, sufficient to bear multidirectional load weight. The VHR mount is composed of a backing or mounting plate which is wider than the space between the vehicle manufacturer's headrest sliding guide rods. The backing plate is fastened mechanically, chemically, or thermally to the mounting rods. The mounting rods are relatively equal in size and shall be no larger in diameter than the vehicle manufacturer's headrest sliding guide rods. The rods are affixed to the backing plate at a 90 degree angle and at an on-center distance equal to that of the vehicle manufacturer's headrest guide rod spacing, allowing for fitment in a multitude of factory vehicles. Once manufactured and installed, the VHR mount allows space along the backing plate for mounting various accessories.

The prototype or preferred embodiment, as described in the BACKGROUND example, was designed for the 2007 Ford Crown Victoria Police Interceptor and is embodied in the included drawings. The backing plate was formed from ⅛″ thick plate hot rolled steel. The backing plate measures 2.5″ by 9″ and is pre-drilled to accept bolting to the Ledco brand printer armrest. The backing plate is held horizontal and the mounting rods are aligned at a 90 degree angle to the backing plate. The mounting rods are approximately 11″ long and ⅜″ in diameter. The rods are formed from ⅜″ diameter hot rolled steel rod. The exposed end of the mounting rod may be rounded or beveled for installation. The mounting rods are then held parallel and welded to the backing plate at a distance of 7″ on-center, and centered over the backing plate. The finished product or preferred embodiment then uses steel set-screw type shaft collars, slightly larger than the diameter of the mounting rods, to adjust the installation height of the VHR mount. The VHR mount requires complete removal of the vehicle manufacturer's headrest. The VHR mount then inserts/installs in the vehicle manufacturer's headrest receptacles, openings, or otherwise existing seat structure. The shaft collars can be set at varying heights, but preferably even, to adjust the final resting height of the backing plate.

### BRIEF DESCRIPTION OF THE DRAWINGS

FIG. 1 is a two dimensional schematic view of the backing plate, also referred to as BP1.

FIG. 2 is a two dimensional schematic view of the mounting rod, also referred to as MR1.

FIG. 3 is a two dimensional schematic view of the assembled mount (CV1) showing two mounting rods (MR1) affixed to the backing plate (BP1) at the stated dimensions, in the preferred embodiment.

### DETAILED DESCRIPTION OF THE INVENTION

In the following description, it is to be understood that descriptive terms and phrases of the like are words of convenience and are no to be used as limiting terms. The included drawings are for the purpose of describing the preferred embodiments of the invention and are not intended to limit the scope of the invention.

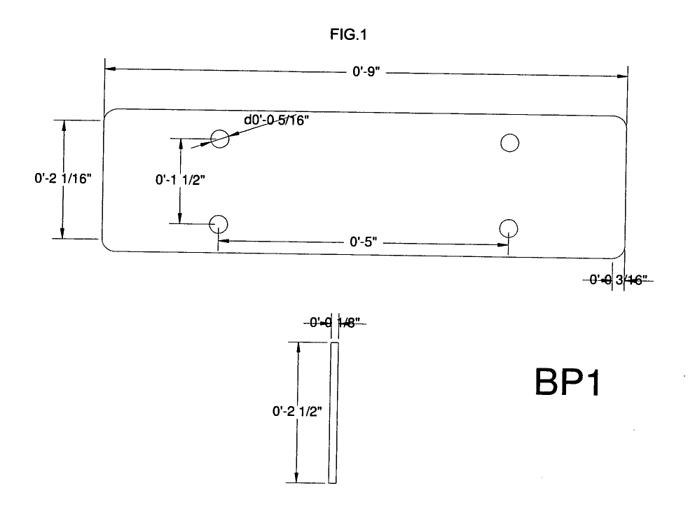

FIG. 1 illustrates the backing plate or mounting plate referred to as BP1. The backing plate, in this example, is formed from rigid ⅛″ thick hot rolled carbon steel plate. The backing plate measures 2.5″ by 9″ with radius corners and a plurality of edges. The backing plate may be cut or drilled, as shown in this example, to accept bolting to certain accessories.

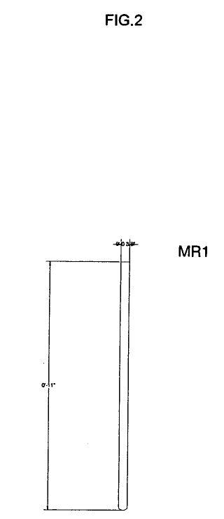

FIG. 2 illustrates the mounting rod referred to as MR1. The mounting rod, in this example, is formed from rigid ⅜″ hot rolled carbon steel rod and measured 11″ long. The ends of the rod may be beveled or rounded for installation purposes. The preferred embodiment requires two (2) mounting rods.

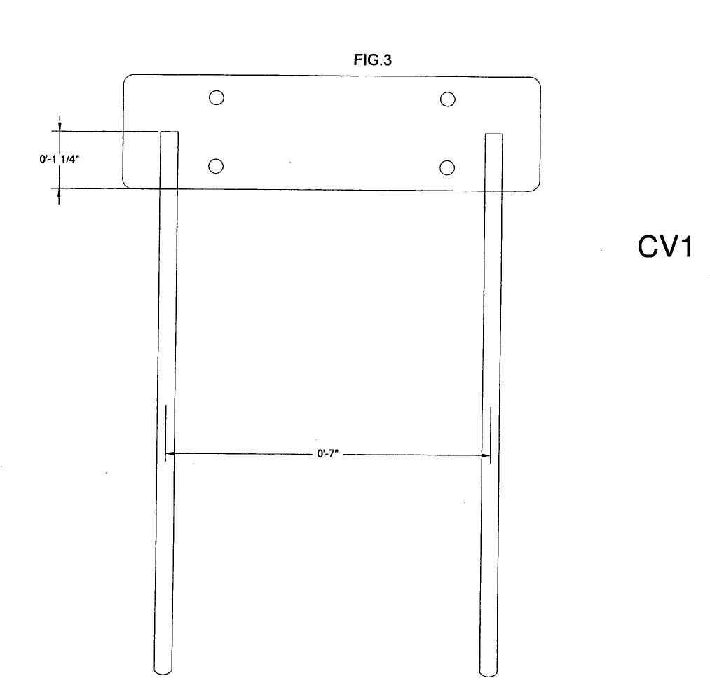

FIG. 3 illustrates the preferred embodiment referred to as CV1. The preferred embodiment is formed by affixing, or in this example welding, two mounting rods perpendicular to the backing plate at a predetermined distance apart, which in this example is 7″ on center. The rods are centered and overlapped approximately 1.25″ over the backing plate, held horizontal, and then welded. The accessory mount then installs, with the rods pointing down, in place of the OEM headrest, using the existing headrest receptacles, openings, or otherwise existing seat structure. The rods simply insert into these existing receptacles or openings. The preferred embodiment uses steel set-screw type shaft collars, slightly larger than the diameter of the mounting rods, and is installed over the rods, to adjust the installation height of the VHR mount. The width of the shaft collars should be wider than that of the existing seat structure receptacles or openings and will function as an obstruction to the VHR rods sliding deeper into the existing receptacle or seat structure. Once installed, the backing plate is exposed and held upright for accessory mounting surface area.

It is apparent to anyone skilled in the art that multiple variations can be made to the stated invention without departing from its spirit and scope. For example, the dimensions of each component part and final assembly dimensions may be changed to provide fitment in various vehicles. Further, the manufacturing material selected may not be precisely the type of the preferred embodiment but rigid enough to support the spirit, scope and purpose of this invention. Finally, angled bends in the component parts may provide for additional accessory mounting options but still does not depart from the spirit, scope, or purpose of this invention. Therefore, the invention is not to be limited by the described embodiment, but rather, the claims put forth in this application for patent.

1. A Vehicle Headrest Accessory mount comprised of a backing or mounting plate affixed to two (2) mounting rods.

2. A Vehicle Headrest Accessory mount, wherein said mount is an improvement of a vehicle seat manufactured or adapted to receive an adjustable headrest and is a unique item of manufacture in its spirit, purpose, and scope by providing surface area to mount unspecified accessories in an otherwise occupied space.

3. A Vehicle Headrest Accessory mount, wherein said mount is constructed of rigid material sufficient to bear multidirectional load forces, no less than may be applied by the attachment of desired accessories, without radical deformation.

4. The Vehicle Headrest Accessory mount of claim 1, wherein said backing plate has a plurality of edges and is minimally as wide as the distance between the affixed parallel mounting rods.

5. The Vehicle Headrest Accessory mount of claim 1, wherein said mounting rods are roughly uniform and affixed parallel to each other but perpendicular to the backing plate.

6. The Vehicle Headrest Accessory mount of claim 1, wherein said mounting rods are affixed to the backing plate at a distance equal to that of the vehicle manufacturers' adjustable headrest guide rod spacing, of which the accessory mount is replacing.
